(19) United States
(12) Patent Application Publication
(10) Pub. No.: US 2015/0161525 A1
(43) Pub. Date: Jun. 11, 2015

(54) Ranking Reserved Seating on Event Management Systems

(71) Applicant: Eventbrite, Inc., San Francisco, CA (US)

(72) Inventors: Shigeki Hirose, Sammamish, WA (US); Jon Bastin, San Francisco, CA (US); Jason Bayly, San Francisco, CA (US); Sean William Porter, San Francisco, CA (US); Kyle O'Brien Crumrine, Oakland, CA (US)

(73) Assignee: Eventbrite, Inc., San Francisco, CA (US)

(21) Appl. No.: 14/099,828

(22) Filed: Dec. 6, 2013

(51) Int. Cl. G06Q 10/02

(52) U.S. Cl. CPC G06Q 10/02

(57) ABSTRACT

In one embodiment, a method includes accessing a seating map of a venue for an event associated with an event-management system, wherein the seating map has a plurality of seats, each seat having a particular location with respect to the seating map, receiving from an event organizer for the event a focal point for the seating map, the focal point having a location with respect to the seating map, and determining a score for each seat based at least in part on the distance between the particular location of the seat and the location of the focal point.

### TECHNICAL FIELD

The present disclosure generally relates to online event management systems and in particular to online management of reserve seating for events.

### BACKGROUND

Many websites allow users to conduct a variety of actions online, such as viewing content, writing reviews, ordering items, purchasing tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event management system. An online event management system may allow an event organizer to organize and manage various aspects of an event, such as, for example, managing attendee registrations and selling tickets, promoting the event, and managing attendee check-in at the event. An online event management system may also allow users to view event profiles, register for events, and purchase tickets for events. Online systems, such as online event management systems, can typically be accessed using suitable browser clients (e.g., MOZILLA FIREFOX, GOOGLE CHROME, MICROSOFT INTERNET EXPLORER).

Particular events may use reserved seating, where attendees purchased tickets for or otherwise register for particular seats at an event venue. The ticket may be purchased by an event attendee either online or at the box office. If the event attendee purchases the tickets online, the receipt may be emailed to the attendee to be shown to an attendant at the event. If the event attendee purchases the ticket at the box office, the attendee may receive a ticket stub which displays the actual seat number that is reserved. Reserving tickets in advance may reduce any unnecessary time spent queuing at the box office, especially in a seating system whose seats may be distributed on a first-come-first-serve basis. Moreover, reserved seating may allow event attendees to select seats that they desire in advance. In other words, reserved seating may allow event attendees to improve their enjoyment of the event without spending much effort to find their favorite seats. Reserved seating may be utilized for a variety of events, such as concerts, plays, spectator sports, or ballets. Tickets for some or all of the reserved seats may be sold in advance of the actual date of event. Event attendees may utilize the online event management system to view the available reserved seats, the location of each reserved seat, and purchase the tickets for the seats.

### BRIEF DESCRIPTION OF THE DRAWINGS

FIG. 1 illustrates an example network environment for implementing an online event management system.

FIG. 2 illustrates an example method for scoring seats.

FIG. 3 illustrates an example graphical user interface (GUI) for managing an event profile.

FIG. 4 illustrates an example for scoring a seat based at least in part on the shortest distance between its location and a focal point in a two-dimensional space of a seating map.

FIG. 5 illustrates an example focal point comprising two geometrical shapes.

FIG. 6 illustrates an example embodiment of visualizing seats rankings based on a grayscale graphical representation.

FIG. 7 illustrates an example computing system.

### DESCRIPTION OF EXAMPLE EMBODIMENTS

### System Overview

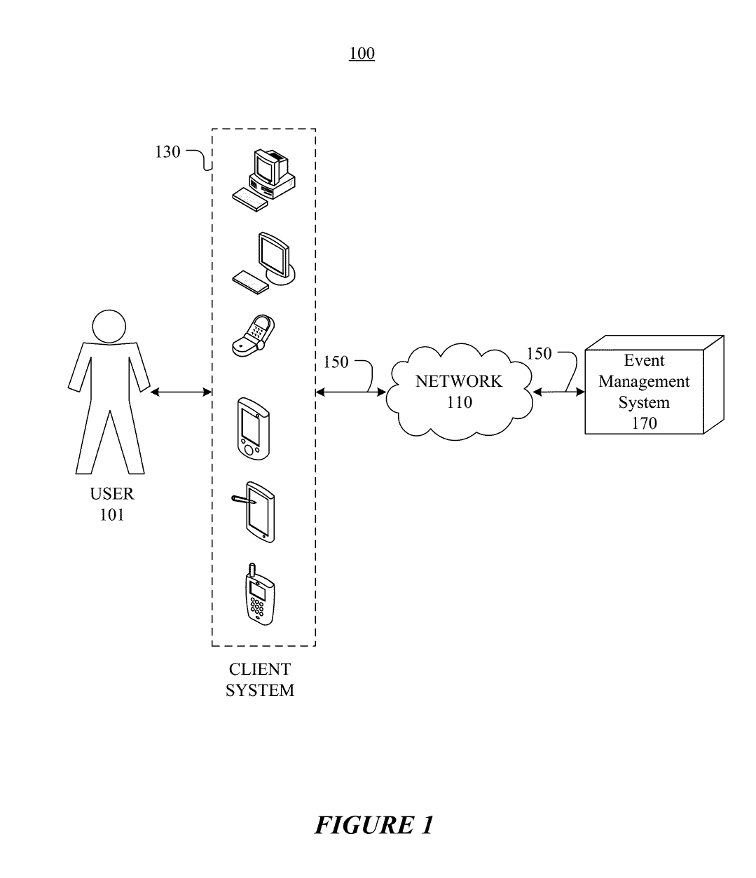

FIG. 1 illustrates an example system 100 for implementing an online event management system. System 100 includes a user 101, a client system 130, and an event-management system 170 connected to each other by a network 110. Although FIG. 1 illustrates a particular arrangement of user 101, client system 130, event-management system 170, and network 110, this disclosure contemplates any suitable arrangement of user 101, client system 130, event-management system 170, and network 110. As an example and not by way of limitation, two or more of client system 130 and event-management system 170 may be connected to each other directly, bypassing network 110. As another example and not by way of limitation, two or more of client system 130 and event-management system 170 may be physically or logically co-located with each other in whole or in part. Moreover, although FIG. 1 illustrates a particular number of users 101, client system 130, event management systems 170, and networks 110, this disclosure contemplates any suitable number or types of users 101, client systems 130, event management systems 170, and networks 110. As an example and not by way of limitation, system 100 may include multiple users 101, client systems 130, event management systems 170, and networks 110.

In particular embodiments, an event-management system 170 may be a network-addressable computing system that can host one or more event organization and management systems. An event-management system 170 may generate, store, receive, or transmit event-related data, such as, for example, event listings, event information details, event history details, event registration details, event organizer details, event attendee details, ticket purchase details, attendee check-in details, or event displays. An event-management system 170 may be accessed by the other components of system 100, for example, directly or via network 110. In particular embodiments, one or more users 101 may use one or more client systems 130 to access, send data to, and receive data from an event-management system 170. A client system 130 may access an event-management system 170 directly, via network 110, or via a third-party system. A client system 130 may be any suitable computing device, such as, for example, a personal computer, a laptop, a cellular phone, a smartphone, a personal digital assistant, an ultra-mobile PC, or a computing tablet.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another suitable network, or a combination of two or more of these. Network 110 may include one or more networks 110.

Connections 150 may connect client system 130 and event-management system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another suitable connection 150, or a combination of two or more such connections 150. Connections 150 need not necessarily be the same throughout system 100. One or more first connections 150 may differ in one or more respects from one or more second connections 150.

### Event Management Systems

In particular embodiments, an event-management system 170 may allow users 101 to create, organize and manage events at a venue. An event may be, for example, a party, a concert, a conference, a sporting event, a fundraiser, a networking event, or a live performance. Events may occur online (such as, for example, a web-based seminar) and offline (such as, for example, a live seminar in a lecture hall). A venue may be, for example, a stadium, a hall, an auditorium, a hotel, a camp site, a beach, a standing area, a general admission area, or any suitable outdoor and indoor locations. An online event management system may allow an event organizer to organize and manage various aspects of an event, such as, for example, creating event profiles, managing attendee registrations and selling tickets, managing funds from ticket sales, promoting the event, and managing attendee check-in at the event. An online event management system may also allow event attendees to view and manage various aspects of registering for an event, such as, for example, viewing event profiles, viewing event history information, registering for events, and purchasing tickets for events. As an example and not by way of limitation, a first user 101 (e.g., an event organizer) may use event-management system 170 to create and organize an event. As used herein, the terms “user” and “event organizer” may be used interchangeably to refer to a user 101 who participates in the creation, production and management of all, or some, aspects of an event. The first user 101 may create an event profile for the event and input event information or event parameters associated with the event. As used herein, the terms “event information” and “event parameter” may be used interchangeably to refer to data in an event profile describing one or more aspects of or related to an event. The event profile may be viewable in one or more webpages or other content served by event-management system 170. A second user 101, or an event attendee, may then use event-management system 170 to register for the event. As used herein, the terms “user” and “event attendee” may be used interchangeably to refer to a user 101 who registers and attends an event. The second user 101 may view an event profile associated with the event and then register or purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event. Furthermore, although this disclosure uses the term “ticket,” this disclosure is applicable to events that do not use physical tickets and even ticketless events where attendees merely register for the event. Thus, unless context suggests otherwise, the term “ticket” (whether alone or when used in conjunction with other terms) may be considered synonymous with “registration.”

In particular embodiments, an event-management system 170 may have an event profile associated with each event managed by the system. An event profile may be accessed and displayed by any suitable client system 130. An event profile may include event information describing the event title, the event date/time, the event category or type, the event details, the description of the event, the event cost or ticket price for the event, the event organizer, the event promoter, the geographic location of the event, the venue for the event, a seating map for the event, a venue capacity, the performer for the event, the number of tickets available for the event, the type/class of tickets available for the event, the ticket identifiers, the number of reserved seats available for the event, the location/type/class of reserved seats available for the event, the selling prices of the reserved seats for the event, the selling order of the reserved seats for the event, the event attendees, the attendee check-in status of each event attendee, the ticket-selling window (a start time and an end time during which tickets can be sold), purchase information for the event, an attendee list for the event, references to additional information (such as, for example, hypertext links to resources related to or describing the event, historical sales data for the seats of the events, and the like), privacy settings for the event profile, or other suitable event information. Although this disclosure describes particular types of event information, this disclosure contemplates any suitable types of event information.

In particular embodiments, the event profile may include an event attendee list. The event attendee list may include, for example, information describing the attendees registered to attend the event, include the attendee's name, phone number, mailing address, email address, IP address, device identifier, purchase information, ticket order information, ticket information, check-in status, and other suitable attendee information. Each attendee may be assigned one or more tickets, and each ticket may have a unique ticket identifier. A ticket identifier may be an identification number, a barcode, a 2D barcode, a QR (quick response) code, or another suitable unique identifier. Although this disclosure describes particular types of information associated with an event attendee list, this disclosure contemplates any suitable types of information associated with an event attendee list.

In particular embodiments, the event profile may include a total number and type of tickets that are available for the event. The type of tickets available for an event may include, for example, premium tickets, general admission tickets, reserved seating tickets, another suitable type of tickets, or two or more such types of tickets. There may be various numbers of each ticket type available for the event. The number of tickets available for an event may be based on a variety of factors. As an example and not by way of limitation, the event organizer or venue owner may specify a particular number of tickets that may be sold for the event. As another example and not by way of limitations, the number of tickets that may be sold may be based on the size or capacity of the venue. Although this disclosure describes particular numbers and types of tickets that are available for an event, this disclosure contemplates any suitable numbers and types of tickets that are available for an event.

In particular embodiments, a first user 101 of event-management system 170 may have at least one associated event profile information. The event profile may include, for example, the type of event such as a concert, a ceremony, a competition, a party, a convention, or other suitable types of event. The event may be located at a public facility, or at a private venue. The event profile may further include, for example, an overall budget for producing the event, a desired date for the event, a list of alternate dates for the event, a location of the venue, seating maps for the venue, a theme for the event, a parking information for the event, signage for the event, human resource support for the event, first aid stations for the event. Although this disclosure describes particular event profile information, this disclosure contemplates any suitable event profile information.

In particular embodiments, the event profile may include reserved seating information for the event. A reserved seating information may include, for example, seating maps for the event at the venue, the total number of reserved seats for sale by the event organizer for each seating map, the location or position of each reserved seat with reference to each seating map, the location or position of each door with reference to each seating map, the location or position of each wheelchair seat with reference to each seating map, the type or class of each reserved seats, an estimated selling price for each reserved seat, a selling order for each reserved seat, or other suitable reserved seats information. Although this disclosure describes particular types of reserved seating information for an event, this disclosure contemplates any suitable types of reserved seating information for any event.

In particular embodiments, the event profile may include financial planning information for an event organizer. A financial planning information may include, for example, a first user 101's name, phone number, mailing address, email address, billing address, payment information, credit card information, bank account number, PAYPAL username, cash payment information, money transfer information, address verification system score for the payment, validity information for the payment, or other suitable purchase information. Although this disclosure describes particular types of financial planning information for an event organizer, this disclosure contemplates any suitable types of financial planning information for any event organizer.

In particular embodiments, the event profile may include purchase information of the event attendee for the event. A purchase information may include, for example, a second user 101's name, phone number, mailing address, email address, billing address, payment information, ticket order information, credit card information, bank account number, PAYPAL username, cash payment information, money transfer information, address verification system score for the payment, validity information for the payment, or other suitable purchase information. Although this disclosure describes particular types of purchase information, this disclosure contemplates any suitable types of purchase information.

In particular embodiments, a second user 101 (or event attendee) of event-management system 170 may have an associated event history information. The event history information may include event information and purchase information associated with one or more events the second user 101 has attended or has registered to attend, as well as purchase history information associated with each event. The event history information may also include event information associated with one or more event profiles the second user 101 has created, organized, and managed. Although this disclosure describes particular event history information, this disclosure contemplates any suitable event history information.

In particular embodiments, the event-management system 170 may use a unique client identifier (ID) to identify a user 101. As an example and not by way of limitation, the event-management system 170 may assign a unique device ID to each client system 130. The event-management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. As another example and not by way of limitation, the event-management system 170 may assign a unique user ID to each user 101, which the user 101 may provide to the event-management system 170 via a client system 130. The event-management system 170 may assign each user 101 with a username and password that the user 101 can input into client system 130, which then transmits the username and password to the event-management system 170. In particular embodiments, the event-management system 170 can use the unique client identifier (such as, for example, a device ID or user ID) to determine that the user 101 is accessing the system. As another example and not by way of limitation, the event-management system 170 may assign a unique client identifier to each attendee of an event. As yet another example, and not by way of limitation, the event-management system 170 may use the unique client identifier to determine whether the user 101 is an event organizer or an event attendee. Although this disclosure describes particular types of unique client identifiers, this disclosure contemplates any suitable types of unique client identifiers. Moreover, although this disclosure describes using client identifiers in a particular manner, this disclosure contemplates using client identifiers in any suitable manner.

In particular embodiments, the event-management system 170 may maintain an event management account for a second user 101. The event management account may contain a variety of information about the second user 101. As an example and not by way of limitation, an event management account may contain personal information (such as, for example, name, sex, location, interests), social network information (such as, for example, friend connections, personal information about second user 101's friends), financial information (such as, for example, income, credit history), event history information (such as, for example, the type, data, cost, venue, performers, geographic location of the events the second user 101 has organized, registered for, or attended), or other suitable information related to the second user 101. Although this disclosure describes event management accounts containing particular types of information about a second user 101, this disclosure contemplates event management accounts containing any suitable information about any second user 101.

In particular embodiments, an event-management system 170 may use a “shopping cart” model to facilitate event registration. As an example and not by way of limitation, event-management system 170 may present a second user 101 with a plurality of event profiles. The second user 101 may select one or more of the events to register for. When the second user 101 selects an event profile on event-management system 170, the event-management system 170 may metaphorically add that item (e.g., registration for the event) to a shopping cart. If appropriate, the second user 101 may also select a ticket type or a number of tickets for the event. When the second user 101 is done selecting event profiles, then all the items in the shopping cart may be “checked out” (i.e., ordered) when the second user 101 provides purchase information (and possibly shipment information). In particular embodiments, when a second user 101 selects an event profile, then that event profile may be “checked out” by automatically prompting the second user 101 for purchase information, such as, for example, the second user's name and purchase information. The second user 101 then may be presented with a registration webpage that prompts the second user 101 for the user-specific registration information to complete the registration. That webpage may be pre-filled with information that was provided by the second user 101 when registering for another event or when establishing an event account on the event-management system 170. The information may then be validated by the event-management system 170, and the registration may be completed. At this point, the second user 101 may be presented with a registration confirmation webpage or a receipt that displays the details of the event and registration details. Event-management system 170 may also charge or withdraw funds from a financial account associated with second user 101 based on the purchase information provided by the second user 101. The “shopping cart” model may be facilitated by a client system 130 operating offline from event-management system 170. Although this disclosure describes particular means for registering for events and purchasing tickets, this disclosure contemplates any suitable means for registering for events and purchasing tickets.

In particular embodiments, an event management system 170 may comprise one or more related services that allow a first user 101 to organize events. As an example and not by way of limitation, event management system 170 may present the first user 101 with software tools to develop an online or a mobile website for each event. The events may include but not limited to, a concert, a conference, a festival, a spectator sport, a performing arts, or a social event. The website may allow a second user 101 to purchase tickets and register for the event. In particular embodiments, the event management system 170 may offer software tools to enable the first user 101 to promote the event. The software tools may present options such as, but not limited to, emailing personalized invitations to pre-determined contacts, listing non-private events on search engine or in public directories, or promoting events to friends via social networks such as Facebook, Twitter, or Linkedin. In other particular embodiments, the event management system 170 may enable the first user 101 to track attendance, including but not limited to, emailing attendees and send event reminders, managing group registration, sending professional invitations, viewing tickets and registration sales, determining the number of attendees, estimating the total revenue from sales of the reserved seats, tracking the sale of each reserved seat, accessing sales data at any time, scanning tickets, and managing discounts, group and members-only registration.

### Managing Reserve Seating

In particular embodiments, an event-management system 170 may enable a first user 101, or an event organizer, to determine a score for each available seat of an event at a venue. In order to accomplish this, the event-management system 170 may first access a seating map of a venue for an event. In particular embodiments, there may have more than one suitable seating map for the event, and the first user 101 may select the most suitable map to be used. The seating map may be a graphical representation of all the seats at the event. The available seats may include reserved seats, and seats that are unassigned. Each reserved seat may be assigned to a ticket at the time of purchase by an event attendee. As an example and not by way of limitation, the ticket may be paper stubs that may be printed at an automated ticket kiosk or be picked up at the box office window. As another example and not by way of limitation, the ticket may be an electronic mail receipt that may enable the user 101 exclusive access to the seat. The event-management system 170 may thereafter utilize, for example, a seat designer GUI 300 to receive a focal point from the event organizer. Upon the receipt of the seating map, the event-management system 170 may determine a score for each seat based at least in part on the distance between its location and the location of the focal point. In particular embodiments, the seats may be substituted by other applicable units at a venue. As an example and not by way of limitation, the event-management system 170 may enable the first user 101 to determine the score for each hotel room at a hotel, each camping lot at a camp site, each standing area at a hall, each general admission area of a festival, or any other suitable units applicable to the event and the venue. Although this disclosure describes the determination of a score for each available seat of an event at a venue by a first user 101 in a particular manner, this disclosure contemplates the determination of the score for each available seat of any event at any venue by any first user 101 in any suitable manner.

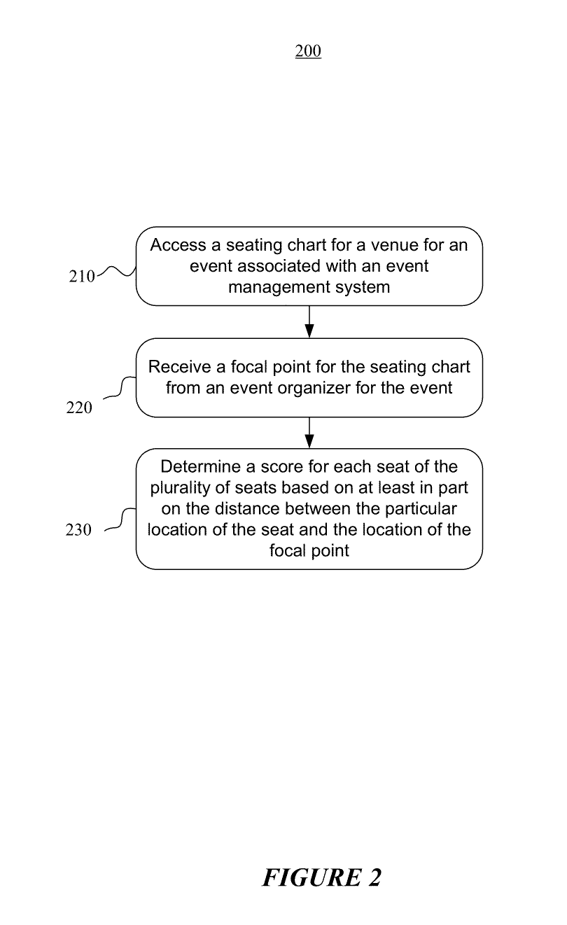

FIG. 2 illustrates an example method for scoring seats. The method 200 may begin at step 210, whereby the event-management system 170 may access one or more seating maps of the venue for the event. A seating map may be, for example, a two-dimensional (2D) or three-dimensional (3D) graphical representation of the venue comprising one or more stages, exits or entrances, wheelchair seats, speakers, other suitable facilities features, or any combination thereof. A stage may be, for example, a theater stage, a sports field, a dance floor, other suitable performance spaces, or any combination thereof. As another example not by way of limitation, for a two-dimensional seating map, each seat or similar facility feature may be represented by a set of one or more geographical X-Y coordinates with reference to a pre-determined point of origin on the seating map. As another example and not by way of limitation, for a three-dimensional seating map, each seat or similar facility feature may be represented by a set of one or more geographical X-Y-Z coordinates with reference to a pre-determined point of origin on the seating map. As yet another example and not by way of limitation, the pre-determined point of origin with reference to each of the two-dimensional and three-dimensional representation of seating maps may be a centroid of the stage or other suitable coordinate on the seating map. In particular embodiments, the seating maps may be stored, retrieved, or transmitted using a computer software digital format. As examples and not by way of limitation, the computer software digital format may include Joint Photographic Expert Group (JPEG), Portable Network Graphics (PNG), and Graphics Interchange Format (GIF). The seating maps may be represented as black and white, grayscale, or color digital images. Although this disclosure describes the representation of a seating map in a particular manner, this disclosure contemplates any representation of any seating map in any suitable manner.

In particular embodiments, the event-management system 170 may receive, at step 220, a focal point for the seating map from a first user 101 or an event organizer. The focal point may be a location with respect to the seating map. As an example and not by way of limitation the focal point may comprise of one or more locations with respect to the seating map. As another example and not by way of limitation, the focal point may comprise one or more geometrical shapes whereby each shape may be selected from a group comprising of a point, a line, an arc, a circle, an oval, an ellipse, an ovoid, an ellipsoid, a polygon, and other suitable shapes. As yet another example and not by way of limitation, for a two-dimensional seating map, the geometrical shape may include a point, a line, an arc, a 2D circle, a 2D oval, a 2D ellipse, a 2D polygon, or other suitable 2D geometrical shapes. The geometrical shape within the two-dimensional seating map may be represented by a plurality of X-Y coordinates on X and Y axises with reference to a pre-determined point of origin on the two-dimensional seating map. As yet another example using a three-dimensional seating map as a reference and not by way of limitation, the geometrical shape may include a point, a line, an arc, a 2D circle, a 2D oval, a 2D ellipse, a 2D polygon, a 3D ellipsoid, a 3D ovoid, a 3D polygon, or other suitable two- or three-dimensional geometrical shapes. The geometrical shape within the three-dimensional seating map may be represented by a plurality of X-Y-Z coordinates on X, Y and Z axises with reference to a pre-determined point of origin on the three-dimensional seating map. In particular embodiments, the focal point may be manually drawn and adjusted by the event organizer using the event-management system 170. In particular embodiments as illustrated in FIG. 2, the event-management system 170 may, for example, via a graphical user interface (GUI), request the event organizer to position one or more target coordinates within the focal point on a two-dimensional or three-dimensional seating map in order to determine the selling order of the seats for the event.

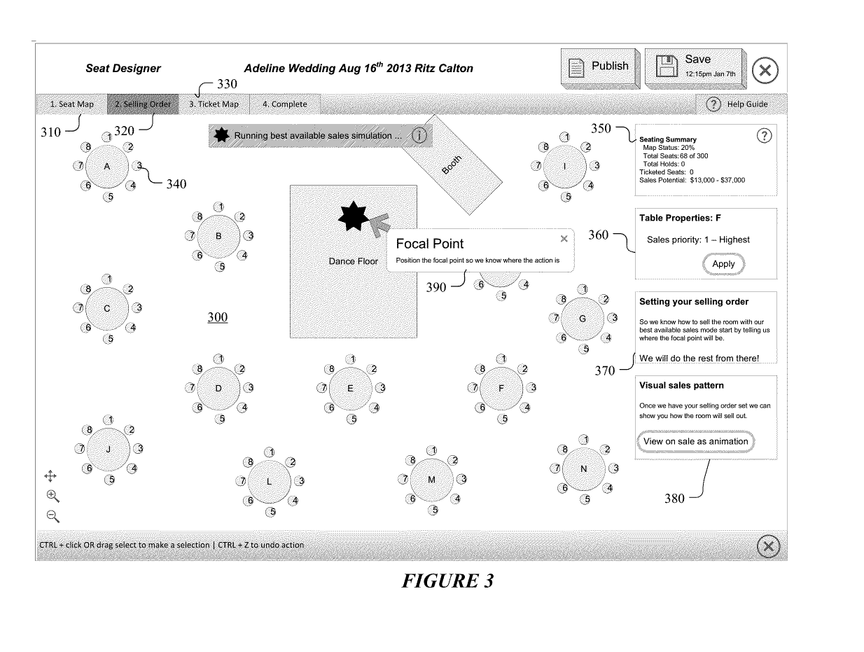

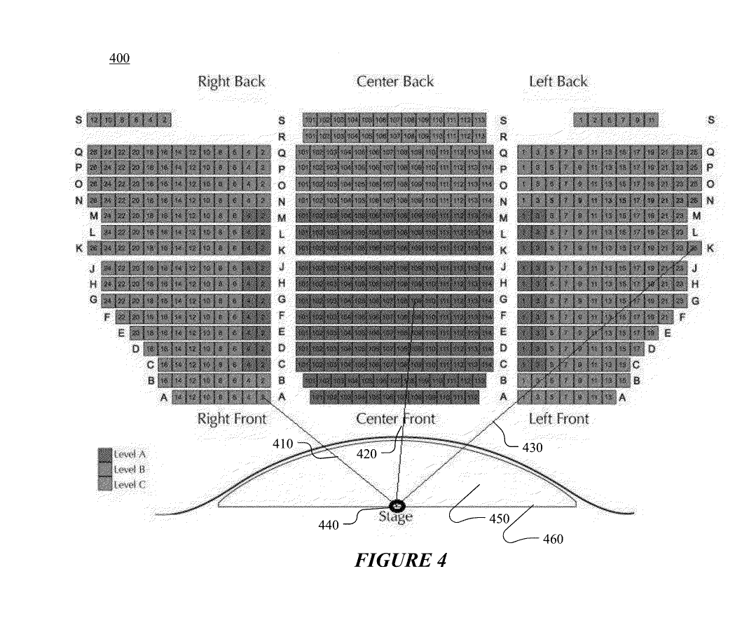

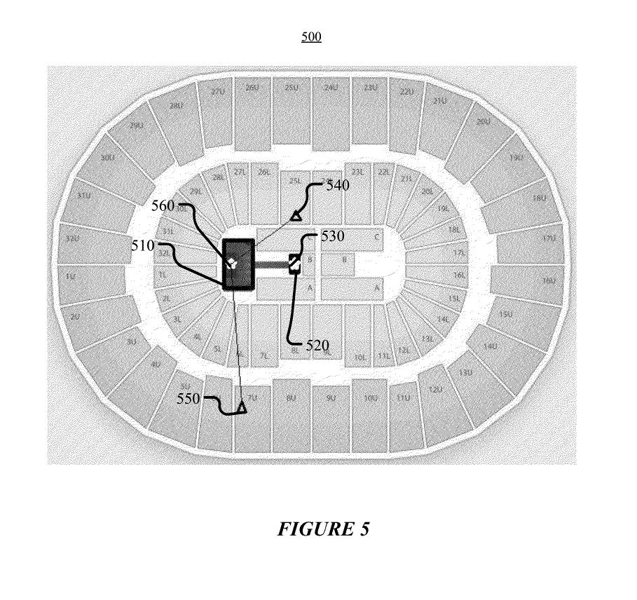

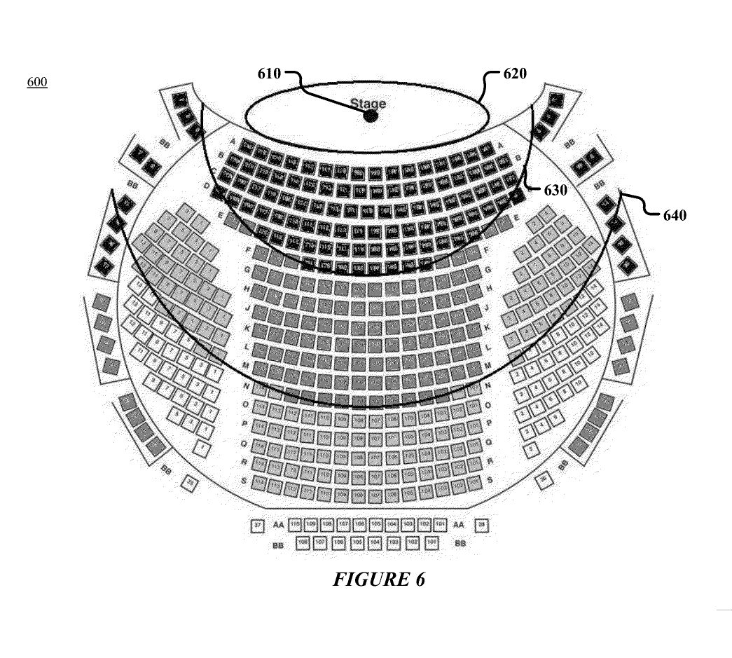

As an example and not by way of limitation, for a focal point whose geometrical shape may be a point as illustrated in FIG. 3, a target coordinate of the focal point may be the focal point. As another example and not by way of limitation, for a focal point whose geometrical shape may not be a point shape as illustrated in FIG. 6, a target coordinate of the focal point may a centroid of the two-dimensional geometrical shape. As yet another example and not by way of limitation, for a focal point whose geometrical shape is not a point as illustrated in FIG. 4, a target coordinate may be a suitable fixed coordinate location on the outline of the geometrical shape. As a last example and not by way of limitation, for a focal point whose geometrical shape is not a point as illustrated in FIG. 5, the target coordinate may be any of the coordinates that make up the two-dimensional shape. In particular embodiments as illustrated in FIG. 3, the event-management system 170 may allow event organizer to manually specify or highlight any fixed coordinate within the focal point as the target coordinate of the focal point. Although this disclosure describes identifying a target coordinate of a focal point in a particular manner, this disclosure contemplates identifying any target coordinate of any focal point in any suitable manner.

In particular embodiments, the focal point may comprise one or more geometrical shapes. As an example and not by way of limitation, an event at a venue may comprise one or more stages. The focal point associated with the seating map of the event may comprise more than one geometrical shape for each of the one or more stages. As another example and not by way of limitation, an event at a venue may comprise an irregular shaped stage as illustrated in FIG. 5. The focal point associated with the two-dimensional seating map of the event may comprise two rectangles that highlight the two possible performing locations of the stage.

In particular embodiments, the event-management system 170 may determine a score for each seat based on the distance between the particular location of the seat and a focal point with respect to the seating map, via step 230. As an example and not by way of limitation, the score may be the shortest distance between the location of the seat and one or more target coordinates of the focal point. As another example and not by way of limitation, the score may relate to an absolute value, a subset, a range, or other suitable numeric values associated with the distance. In particular embodiments, the score for each seat may be stored in a coupled storage system associated with the event-management system 170. In particular embodiments, the scores for the seats may be inputs to an algorithm to determine other variables.

In particular embodiments where a focal point comprises one or more geometrical shapes, the score for each seat may be based on a multivariate algorithm taking into consideration one or more inputs comprising the particular location of the seat and the locations of the one or more target coordinates of the focal point. As an example and not by way of limitation, the score of a seat may be determined by the shortest distance between its location and the closest target coordinate of the geometrical shapes as illustrated in FIG. 5. As another example and not by way of limitation, the event organizer may manually select one of the geometrical shapes as the main focal point and the score of a seat may subsequently be determined by the shortest distance between its location and the target coordinate of the focal point. Although this disclosure describes a score for each seat as determined by its location and a focal point in a particular manner, this disclosure contemplates a score for each seat as determined by its location and the location of any focal point in any suitable manner.

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for scoring seats, including the particular steps of the method of FIG. 2, this disclosure contemplates any method for scoring seats, including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

In particular embodiments, the event-management system 170 may further determine a score for each seat based on one or more additional seat attributes. The additional seat attributes may include, but not limited to types of seats (e.g., aisle, handicap-accessible, orchestra, mezzanine/balcony, standing only, extra legroom, etc.), proximity to exits, proximity to loudspeakers, proximity to suitable desirable features, or other suitable seat attributes. In particular embodiments, the event-management system 170 may further determine a score for each non-seat associated unit based on one or more additional applicable attributes. As an example and not by way of limitation, additional attributes to be considered for scoring each camping lot at a camp site may include proximity to a river, mountain view, and one or more assigned parking lots. In particular embodiments, the event-management system 170 may further determine a score for each seat based on historical sales data that more accurately reflects the desirability of the seat. The historical sales data may include, as examples, relative selling sequence and actual selling price of each seat, other suitable historical sales data associated with similar seating maps of past events at the same venue, or any combination thereof.

In particular embodiments, the event-management system 170 may further establish a rank for each seat of a subset of, or the entire, seats of the seating map based on the relative score determined for each seat. As example and not by way of limitation, the first user 101 or the event organizer may use the rankings to identify the highest ranked seats as the “best” seats. In particular embodiments, the event-management system 170 may further establish one or more groupings of the seats based on the relative score determined for each seat. As example and not by way of limitation, seats may be divided into four groups or quartiles, each containing equal number of seats. Each group of seats may be assigned one or more distinct properties that may affect the sales of the seats. In particular embodiments, the event-management system 170 may further establish a selling order of the seats based on the relative score determined for each seat. As example and not by way of limitation, seats that receive relatively lower scores may be targeted for earlier sale than seats that receive higher scores. As another example and not by way of limitation, seats that receive relatively lower score may be subjected to more intense marketing campaigns compare to seats that receive higher scores. In particular embodiments, the event-management system 170 may further establish an estimated selling price of each seat based on its relative score determined and one or more reference selling prices. As an example and not by way of limitation, the first user 101 may determine one or more seats whose scores may be used as references. The event-management system 170 may then proceed to retrieve from the first user 101 the selling prices for the reference scores. Thereafter, the event-management system 170 may apply an algorithm to determine the estimated selling price of any selected seat based on its relative score and the pre-determined selling prices for the one or more reference scores. Instead of applying the algorithm to automatically determine the selling price for each seat, the first user 101 (or the event organizer) may interact with the event-management system 170 to manually adjust the selling prices for one or more seats, according to some embodiments. In particular embodiments, the event-management system 170 may determine the estimated total revenue from sales of one or more subsets of the seats based on the estimated selling price for each of the seat. As an example and not by way of limitation, the estimated total revenue may be the sum of all the estimated selling prices for the one or more subsets of the seats. In particular embodiments, the first user 101 or the event organizer may develop one or more dynamic algorithms, based on the estimated selling price for each seat, to solve for one or more desired sales-related variables. As an example and not by way of limitation, the event-management system 170 may receive from the event organizer, a dynamic algorithm that takes as variables comprising selling prices for one or more reference scores, the seats, the total number of seats, the estimated total revenue, the estimated selling price for the highest scored seat, other suitable variable, or any combination thereof. The event organizer may enter a constant and desired value for the estimated total revenue, while the system-management system 170 may then automatically determine the selling prices for one or more reference scores based on the score for each seat.

FIG. 6 illustrates an example embodiment of visualizing seats rankings based on a grayscale graphical representation. In particular embodiments, the event-management system 170 may utilize Computer Aided Drawing (CAD) software tools to digitally represent each score of the seats graphically. As an example and not by way of limitation, the digital graphical representation of the scores for the seats may comprise a heat map. As further examples and not by way of limitation, the heat map may be represented by various color schemes comprising color gradient, alpha gradient, grayscale, rainbow, or a custom rendering scheme. The custom rendering scheme may reflect a theme associated with an event. As an example and not by way of limitation, a custom rendering heat map scheme associated with the San Francisco Giants at a sports spectator event in the San Francisco Bay Area may include any shades of colors such as, but not limited to, orange, black, white, and gray, which are colors associated with the San Francisco Giants. As another example and not by way of limitation, the score for each seat may be graphically represented using a grayscale heat map as illustrated in FIG. 6. As yet another example and not by way of limitation, a particular shade of a grayscale may be mapped to a range of scores. Hence all seats whose scores fall within a range may be represented by similar shade of gray. As a last example and not by way of limitation, the score for each seat may be graphically represented using a multi-color heat map, such that a particular shade of color may be mapped to one or more scores. Although this disclosure describes the graphical representation of each score in a particular manner, this disclosure contemplates the graphical representation of any score in any suitable manner.

In particular embodiments, an event organizer or a first user 101 may store the seating map and the determined score for each seat of the seating map in a coupled system storage associated with the event-management system 170. As an example and not by way of limitation, the seating map and/or the stored scores may be associated with one or more security attributes comprising, for example, a username, a password, and an identification associated with the event. The security attributes may enable selected users 101 or event organizers of the event-management system 170 restricted accesses to the seating map and/or the stored scores. As another example and not by way of limitation, the event organizer or first user 101 may enable any user 101 of the event-management system 170 unrestricted access to the seating map and/or stored scores for the event, or similar events, at the venue. As yet another example and not by way of limitation, the original event organizer or first user 101 who first create and store the scores may grant limited, or in certain cases unrestricted, access for the seating map and/or stored scores to one or more third-party users 101 of the event-management system 170. In particular embodiments, the event organizer or the first user 101 may store and manage accesses to the established ranks, selling order, estimated selling prices, or the graphical representations of the seats in similar embodiments as discussed. Although this disclosure describes storing and managing accesses to the scores and other related established data of the seats in a particular manner, this disclosure contemplates storing and managing accesses to any scores and any other related established data of the seats in any suitable manner.

FIG. 3 illustrates an example graphical user interface (GUI) for managing an event profile. In particular embodiments, the event-management system 170 may transmit the GUI to a display communicatively coupled with the event-management system 170. The event organizer, or the first user 101, may utilize the GUI to develop and manage a profile for an event at a venue. As an example and not by way of example, a seat designer GUI 300 associated with an event-management system 170, may enable one or more event organizers to create and manage a profile for Adeline's wedding event that will be taking place at the Ritz Calton on Aug. 16th 2013 as illustrated in FIG. 3. The seat designer GUI 300 may enable the event organizers to develop one or more seat maps per Seat Map tab 310, analyze a selling order for the reserved seats per Selling Order tab 320, and determine an estimated ticket price for each reserved seat per Ticket Map tab 330. As illustrated in FIG. 3, the event-management system 170 currently assists one of the event organizers to analyze the selling order for the seats based on the completed seat map. As an example illustrate in FIG. 3 and not by way of limitation, the seat designer GUI 300 may prompt the event organizer to position a focal point on the seat map via dialog box 390. Thereafter the event-management system 170 may perform the methods as illustrated in FIG. 2 to score the each reserved seat. Using the scores of the reserved seats, the event-management system 170 may analyze and produce the selling order for the reserved seats according to particular embodiments. Once the selling order for the reserved seats has been analyzed, the event organizer may proceed to click on the Ticket Map tab 330 to determine the estimated ticket price for each reserved seat according to certain embodiments.

The seat map, as illustrated in FIG. 3, comprises thirteen tables whereby each table further comprises eight chairs. Each table and chair are uniquely identified with an character. As an example and not by way of limitation, chair 340 may be identified as A6. All the tables and chairs are strategically placed around a dance floor such that each event attendee may view the activity on the dance floor optimally. In particular embodiments as illustrated in FIG. 3, the seat designer GUI 300 may display sales information in one or more text boxes. The sales information may include, for example, a seating summary, table properties, a brief instructional summary, a visual sales pattern, other suitable sales information, or any combination thereof. As an example not by way of limitation, the seating summary may include a current completion status of the seat map, a maximum capacity of seats for the venue, a total number of seats reserved by the event organizer for sale, a number of ticketed seats for the event, and an estimated total revenue from sales of the reserved seats as illustrated by a text box 350 in FIG. 3, As another example and not by way of limitation, the table properties may include selling order or priority for each table as illustrated by a text box 360 in FIG. 3. The event organizer may manually adjust the selling priority for one or more table. As yet another example and not by way of limitation, the brief instructional summary may include a brief title and explanation of the current step as illustrated by a test box 370 in FIG. 3. As a last example and not by way of limitation, the visual sales pattern may provide a graphical or video animation of a sequence in the sales of the reserved seats associated with one or more selling order sets as illustrated by a text box 380 in FIG. 3, that may further include one or more historical data. In certain embodiments, the historical data may be obtained from previous similar events at the same venue or other venues.

In particular embodiments, the event organizer may store complete and incomplete data for a seat map, a selling order and a ticket map generated by the seat designer GUI 300 in one or more coupled storage systems. In particular embodiments, the event organizer may utilize the seat designer GUI 300 to publish data associated with the seat map, the selling order, or the ticket map for further review or distribution.

Although this disclosure describes a GUI that enables event organizers to manage event profiles in a particular manner, this disclosure contemplates any GUIs that enable event organizers to manage event profiles in any suitable manner. Particular embodiments may repeat one or more elements of FIG. 3, where appropriate. Although this disclosure describes and illustrates particular elements of the GUI of FIG. 3 as placed in a particular order, this disclosure contemplates any suitable elements of the GUI of FIG. 3 as placed in any suitable order. Moreover, although this disclosure describes and illustrates an example GUI for managing event profiles, including the particular steps of the method of FIG. 3, this disclosure contemplates any GUI for managing event profiles, including any suitable steps, which may include all, some, or none of the steps of the method of FIG. 3, where appropriate. Furthermore, although this disclosure describes and illustrates particular components, devices, or systems carrying out particular steps of the GUI of FIG. 3, this disclosure contemplates any suitable combination of any suitable components, devices, or systems carrying out any suitable steps of the GUI of FIG. 3.

FIG. 4 illustrates an example for scoring a seat based at least in part on the shortest distance between its location and a focal point in a two-dimensional space of a seating map. As an example and not by way of limitation, FIG. 4 illustrates a two-dimensional seating map 400 of the Nightingale Concert Hall at the University of Nevada, Reno. In particular embodiments as illustrated by FIG. 4, each seat of the seating map may be uniquely identified by a row letter selected from A-S and column number selected from 1-114. The seating map may further comprise a stage 450 whose outline 460 may be the focal point of the seating map. As an example and not by way of limitation, an event organizer may further select a X-Y coordinate along the outline 460 of the stage 450 to be the target coordinate 440 of the focal point for scoring each seat. In particular embodiments, an event-management system 170 may determine a score for each seat based on the shortest straight-line distance between its X-Y coordinate and the target coordinate 440 of the focal point 450. As an example and not by way of limitation, for the seating map as illustrated by FIG. 4, the score for seat A2 may be based at least in part on the distance 410 between its X-Y coordinate and the target coordinate 440. As another example and not by way of limitation, the score for seat G109 may be based at least in part on the distance 420 between its X-Y coordinate and the target coordinate 440. As yet another example and not by way of limitation, the score for seat K25 may be based at least in part on the distance 430 between its X-Y coordinate and the target coordinate 440.

In particular embodiments, the event-management system 170 may apply one or more algorithms to the score obtained for each of the seats to further establish, for example, a rank for each of the seat, a selling order for the seats, groupings for the seats, or an estimated ticket price for each of the seats.

Although this disclosure describes an example for scoring a seat based at least in part on its location and a focal point of a seating map, this disclosure contemplates any suitable means for scoring any seat based on its location and any focal point of any seating map. Particular embodiments may repeat one or more elements of FIG. 4, where appropriate. Although this disclosure describes and illustrates particular elements of FIG. 4 as placed in a particular order, this disclosure contemplates any suitable elements of FIG. 4 as placed in any suitable order. Furthermore, although this disclosure describes and illustrates particular components, devices, or systems carrying out particular steps of scoring each seat in FIG. 4, this disclosure contemplates any suitable combination of any suitable components, devices, or systems carrying out any suitable steps of scoring each seat in FIG. 4.

FIG. 5 illustrates an example focal point comprising two geometrical shapes. As an example and not by way of limitation, FIG. 5 illustrates a two-dimensional seating map 500 of a Justin Bieber concert at the Birmingham Jefferson Convention Complex. In particular embodiments, an event at a venue may comprise an irregular-shaped stage as illustrated in the two-dimensional seating map 500 of FIG. 5. The irregular-shaped stage may comprise a main stage and a front stage. In particular embodiments, the event organizer may utilize the seat designer GUI illustrated in FIG. 3 to highlight a focal point that comprises two geometrical shapes to highlight the two possible locations of performances, at the main stage and the front stage respectively. As an example and not by way of limitation, Rectangle 510 may serve as a first geometrical shape for the main stage and Rectangle 520 may serve as a second geometrical shape for the front stage. In particular embodiments, the event organizer may further position a target coordinate in each of the rectangles for scoring each seat of the seating map 500. As an example and not by way of limitation, the event organizer may utilize the seat designer GUI as illustrated in FIG. 3 to further position target coordinate 560 in Rectangle 510, and target coordinate 530 in Rectangle 520.

In particular embodiments, the event-management system 170 may score one or more seats based on the shortest distance between its X-Y coordinates and the target coordinate of the focal point that may be closest to the seat. As an example and not by way of limitation, seat 550 may be closest to target coordinate 560 as illustrated in FIG. 5. Hence the score of seat 550 may be based in part on the shortest distance between its X-Y coordinate and target coordinate 560. In other particular embodiments, the event-management system 170 may score one or more seats based on the shortest distance between its X-Y coordinates and a pre-determined target coordinate. As an example and not by way of limitation, seat 540 may be scored based at least in part on the distance between its X-Y coordinates and target coordinate 560 as illustrated in FIG. 5, even though it may be closer to target coordinate 530.

Although this disclosure describes an example of a focal point comprising two geometrical shapes, this disclosure contemplates any suitable number of geometrical shapes for any focal point in any manner. Particular embodiments may repeat one or more elements of FIG. 5, where appropriate. Although this disclosure describes and illustrates particular elements of FIG. 5 as placed in a particular order, this disclosure contemplates any suitable elements of FIG. 5 as placed in any suitable order. Furthermore, although this disclosure describes and illustrates particular components, devices, or systems carrying out particular steps of scoring each seat in FIG. 5, this disclosure contemplates any suitable combination of any suitable components, devices, or systems carrying out any suitable steps of scoring each seat in FIG. 5.

FIG. 6 illustrates an example embodiment of visualizing seats rankings based on a grayscale graphical representation. In particular embodiments, the score for each seat at an event may be based on the distance between the location of the seat and a focal point, and one or more additional attributes of the seat. The additional seat attributes may include, but not limited to types of seats (e.g., aisle, handicap-accessible, orchestra, mezzanine/balcony, standing only, extra legroom etc.), proximity to exits, proximity to loudspeakers, or other suitable seat attributes. In particular embodiments, the event-management system 170 may further determine a score for each seat based on historical sales data that more accurately reflects the desirability of the seat. The historical sales data may include, as examples, relative selling sequence, relative actual selling price of each seat, or other suitable historical sales data, associated with similar seating maps of past events at the same venue.

As an example and not by way of limitation, the seats may be categorized by types comprising Left, Center, Front, and Private Side Viewing as illustrated by FIG. 6. The seats may be scored based in part on their distances from the focal point 610 of the stage. As another example and not by way of limitation, all seats within a first boundary 630 may be at a first distance from the focal point 610 of stage. All seats within a second boundary 640 may be at a second, and longer, distance from the focal point 610 of stage. In particular embodiments, each seat of the seating map 600 may be scored by an event-management system 170 based at least in part on its type, and its distance from the focal point 610. In particular embodiments, each seat in FIG. 6 may further be graphically represented using a 2 bits grayscale within a seat designer GUI as illustrated in FIG. 3, such that each seat may be represented by one of four shades of gray. Each shade of gray may be related to a subset of the overall scores reflecting the ranks of the seats. As an example and not by way of limitation, seats whose scores fall within a top rank of the overall scores may be graphically represented by a darkest gray tone. As illustrated in FIG. 6, these seats may be of the Center type, and located within the first boundary 630. As another example and not by way of limitation, seats whose scores fall within a bottom rank of the overall scores are graphically represented by a lightest gray tone. As illustrated in FIG. 6, these seats may be of the Left and Right types, and located beyond the second boundary 640.

Although this disclosure describes graphically representing a ranking of seats in a particular manner, this disclosure contemplates graphically representing any ranking of seats in any manner. Particular embodiments may repeat one or more elements of FIG. 6, where appropriate. Although this disclosure describes and illustrates particular elements of FIG. 6 as placed in a particular order, this disclosure contemplates any suitable elements of FIG. 6 as placed in any suitable order. Furthermore, although this disclosure describes and illustrates particular components, devices, or systems carrying out particular steps of graphically representing the rank of each seat in FIG. 6, this disclosure contemplates any suitable combination of any suitable components, devices, or systems carrying out any suitable steps of graphically representing the rank of each seat in FIG. 6.

### Systems and Methods

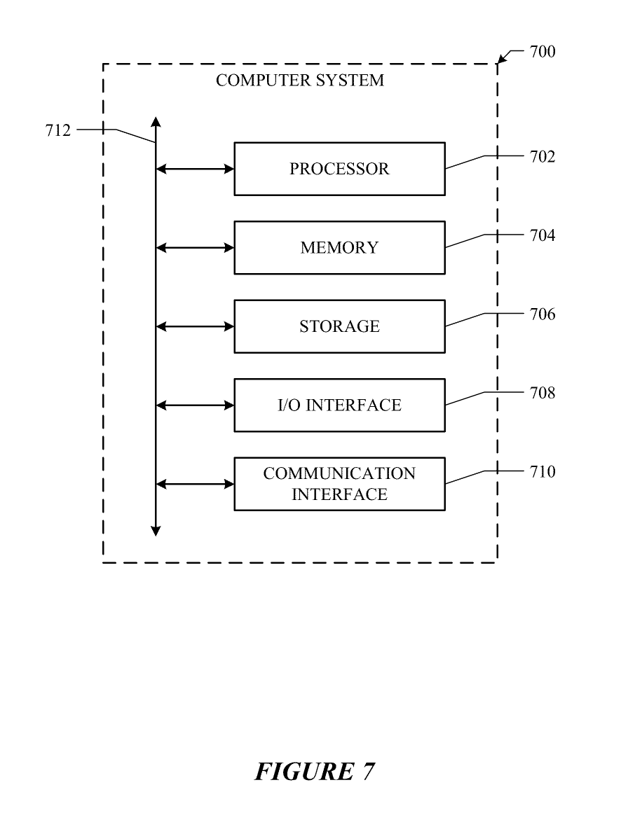

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
accessing, by a computing device, a seating map of a venue for an event associated with an event-management system, wherein the seating map comprises a plurality of seats, each seat having a particular location with respect to the seating map;
receiving, by the computing device, from an event organizer for the event, a focal point for the seating map, the focal point having a location with respect to the seating map; and
determining, by the computing device, a score for each seat of the plurality of seats based at least in part on the distance between the particular location of the seat and the location of the focal point.

2. The method of claim 1, wherein the particular location of each seat of the plurality of seats and the location of the focal point are represented by:
a plurality of X-Y-Z coordinates in a three-dimensional (3D) space of the seating map; or a plurality of X-Y coordinates in a two-dimensional (2D) space of the seating map.

3. The method of claim 2, wherein the focal point includes one or more geometrical shapes; the geometrical shape is selected from a group comprising: a point, a line, an arc, a 2D circle, a 2D oval, a 2D polygon, a 2D ellipse, a 3D ellipsoid, a 3D ovoid, and a 3D polygon.

4. The method of claim 3, wherein determining the score for each seat is further based at least in part on the distance between the particular location of the seat and a position in one of the geometrical shapes, wherein the position is closest to the particular location of the seat.

5. The method of claim 4, wherein the position is a centroid of the one of the geometrical shapes, or a coordinate on the edge of the one of the geometrical shapes.

6. The method of claim 3, wherein determining the score for each seat is further based at least in part on a multivariate algorithm taking into consideration one or more inputs, the inputs comprising the particular location of the seat and locations of the geometrical shapes.

7. The method of claim 1, wherein the determination of the score for each seat of the plurality of seats is further based on one or more seat attributes.

8. The method of claim 1, wherein the determination of the score for each seat of the plurality of seats is further based on a historical sales data that reflects the desirability of the seat.

9. The method of claim 1, further comprising:
establishing, based on the determined score of each seat of the plurality of seats, a ranking of the seats.

10. The method of claim 1, further comprising:
establishing, based on the determined score for each seat of the plurality of seats, one or more groupings of the seats.

11. The method of claim 1, further comprising:
establishing, based on the determined score of each seat of the plurality of seats, a selling order of the seats.

12. The method of claim 1, further comprising:
establishing, based on the determined score of each seat of the plurality of seats, selling prices of the seats.

13. The method of claim 1, further comprising:
storing the seating map and the determined scores for each of the seats.

14. The method of claim 1, further comprising:
sharing the seating map and the determined scores for each of the seats with one or more users of the event-management system.

15. The method of claim 1, further comprising:
transmitting the seating map for display, wherein the determined score for each of the seats is displayed using a heat map.

16. The method of claim 1, further comprising:
applying an algorithm to one or more inputs to assign an estimated selling price for each seat in order to obtain an estimate of the total revenue from sales of the seats, the inputs comprising the determined score of the seat and selling prices for one or more reference scores.

17. The method of claim 16, wherein the estimated selling price for one or more seats is manually adjusted by the event organizer.

18. The method of claim 1, further comprising:
developing, based on the determined score of each seat of the plurality of seats, one or more dynamic algorithms to solve for one or more desired sales-related variables.

19. One or more computer-readable non-transitory storage media embodying instructions that are operable when executed to:
access a seating map of a venue for an event associated with an event-management system, wherein the seating map comprises a plurality of seats, each seat having a particular location with respect to the seating map;
receive, from an event organizer for the event, a focal point for the seating map, the focal point having a location with respect to the seating map; and
determine a score for each seat of the plurality of seats based at least in part on the distance between the particular location of the seat and the location of the focal point.

20. A system comprising: one or more processors; a memory coupled to the processors comprising instructions executable by the processors, the processors being operable when executing the instructions to:
access a seating map of a venue for an event associated with an event-management system, wherein the seating map comprises a plurality of seats, each seat having a particular location with respect to the seating map;
receive, from an event organizer for the event, a focal point for the seating map, the focal point having a location with respect to the seating map; and
determine a score for each seat of the plurality of seats based at least in part on the distance between the particular location of the seat and the location of the focal point.
